(19) United States
(12) Patent Application Publication
(10) Pub. No.: US 2011/0032214 A1
(43) Pub. Date: Feb. 10, 2011

(54) FRONT LIGHT BASED OPTICAL TOUCH SCREEN

(75) Inventors: Russell Wayne Gruhlke, Milpitas, CA (US); Jonathan Charles Griffiths, Fremont, CA (US); Manish Kothari, Cupertino, CA (US)

Correspondence Address: KNOBBE, MARTENS, OLSON & BEAR, LLP, 2040 MAIN STREET, FOURTEENTH FLOOR, IRVINE, CA, 92614, US

(73) Assignee: QUALCOMM MEMS TECHNOLOGIES, INC., San Diego, CA (US)

(21) Appl. No.: 12/790,510

(22) Filed: May 28, 2010

Related U.S. Application Data
(60) Provisional application No. 61/217,534, filed on Jun. 1, 2009.

(51) Int. Cl. G06F 3/042; G02B 26/00; B23P 11/00

(52) U.S. Cl. 345/175; 359/291; 29/428

(57) ABSTRACT

Systems and methods, to integrate an optical touch screen with a display device comprising a front illumination system, are disclosed. Disclosed embodiments comprise a front illumination system, a display device further comprising a plurality of light-modulating elements (e.g. interferometric modulators), a plurality of reflectors and a plurality of sensor arrays. Light from the front illumination system not directed towards the display device is reflected by the reflectors towards the sensor arrays.

### CROSS-REFERENCE TO RELATED APPLICATIONS

This application claims priority benefit under 35 U.S.C. §119(e) of U.S. Provisional Application Ser. No. 61/217,534 filed on Jun. 1, 2009, titled “Front Light Based Optical Touch Screen” (Atty. Docket No. QCO.264PR), which is hereby expressly incorporated herein by reference in its entirety.

### BACKGROUND OF THE INVENTION

1. Field of the Invention

The present invention relates to microelectromechanical systems (MEMS), and more particularly to displays comprising MEMS. Some aspects of this disclosure also relate to integrating a display device, comprising a front illumination system, with an optical touch screen.

2. Description of the Related Art

Microelectromechanical systems (MEMS) include micro mechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY OF THE INVENTION

Various embodiments described herein disclose a display device comprising a front illumination system and an optical touch screen. Various embodiments of the display device comprise a plurality of display elements and a front illumination system. The front illumination system can comprise a source of light and a light guide having a plurality of turning features for providing front illumination to the plurality of display elements. Various embodiments of the display device also comprise an array of sensors disposed forward of the light guide and arranged along a plurality of edges of the light guide. A portion of the light that exits the light guide through one or more edges is directed towards the plurality of sensors to create a sheet of light or a light grid above the light guide. In some embodiments, the portion of the guided light that is not directed towards the display elements and exits the light guide is directed towards the plurality of sensors. The position of an object, for example, a finger or a pen that obstructs or interrupts the propagation of the rays of light comprising the light sheet can be determined by identifying the sensors that indicate a change of state.

Various embodiments of a display device comprising a light guide having a forward and a rearward surface, the light guide further comprising a plurality of edges between the forward and the rearward surfaces are described. Various embodiments of the display device further comprise at least one light source configured to inject light into the light guide such that light propagates through the light guide. In various embodiments, the display device may comprise a plurality of turning features configured to direct light propagating through the light guide towards the rearward surface of the light guide. In various embodiments, at least one array of sensors may disposed forward of the light guide; and at least a first reflector may be configured to receive a portion of the light propagating within the light guide that exits the light guide through one of the edges and to direct said portion of the light towards the array of sensors.

Various embodiments of a display device comprising a means for guiding light having a forward and a rearward surface, the light guiding means further comprising a plurality of edges between the forward and the rearward surfaces are described. Various embodiments of the display device further comprise at least one light emitting means configured to inject light into the light guiding means such that light propagates within the light guiding means. In various embodiments, a plurality of means for turning light configured to direct light propagating within the light guiding means towards the rearward surface of the light guiding means may be provided. In various embodiments, means for sensing light may be disposed forward of the light guiding means. In various embodiments, the display device may comprise at least one means for reflecting light configured to receive a portion of the propagating light that exits the light guiding means through one of the edges and to direct said portion of the light towards the array of sensing means.

Various embodiments include a method of manufacturing a display device. The method comprises providing a light guide comprising a forward and a rearward surface and including a plurality of edges between said forward and rearward surfaces. The method further comprises providing at least one light source configured to inject light into the light guide such that light propagates through the light guide. The method further comprises providing a plurality of turning features on the light guide, said turning features configured to direct light propagating through the light guide towards the rearward surface of the light guide and providing at least one array of sensors disposed forward of the light guide. Additionally, the method comprises providing at least one reflector configured to receive a portion of the light propagating within the light guide that exits the light guide through one of the edges and to direct said portion of the light towards the array of sensors.

Various embodiments include a method of using a display device comprising an optical touch screen is disclosed. The method comprises injecting light from a light source into a light guide comprising a forward and a rearward surface and including a plurality of edges between said forward and rearward surfaces. The method further comprises propagating the injected light through the light guide and redirecting a portion of the propagated light that exits the light guide towards at least one array of sensors using at least one reflector, said at least one array of sensors comprising a plurality of sensors that are configured to sense the redirected light. The method further comprises forming a sheet of light forward of the light guide, said sheet of light comprising the redirected light; and determining a position of an object obstructing said sheet of light by detecting a change of state in one or more sensors.

Various embodiments of a display device comprising a light guide having a forward and a rearward surface are described. Various embodiments of the display device further comprise at least one light source configured to inject light into the light guide such that light propagates through the light guide. In various embodiments, the display device may comprise a plurality of turning features configured to direct light propagating through the light guide towards the rearward surface of the light guide. In various embodiments, at least one array of sensors may disposed forward of the light guide; and at least a first reflector may be configured to receive a portion of the light propagating within the light guide and direct said portion of the light towards the array of sensors.

Various embodiments disclose a display device comprising a light guide having a forward and a rearward surface. In various embodiments, the light guide can include a plurality of edges between the forward and the rearward surfaces. The display device comprises at least one light source configured to inject light into the light guide such that light propagates through the light guide. In various embodiments, the display device further comprises a plurality of turning features configured to direct light propagating through the light guide towards the rearward surface of the light guide and at least one array of sensors disposed forward of the light guide. The display device further comprises at least a first reflector disposed proximal to an edge of the light guide and configured to receive a portion of the light propagating within the light guide that approaches said edge and direct said portion of the light towards the at least one array of sensors.

In some embodiments, the first reflector may be disposed at one edge of the light guide and configured to receive a portion of the light propagating within the light guide that reaches said edge and direct said portion of the light towards the at least one array of sensors. In various embodiments, the first reflector forms the edge of the light guide. For example, in various embodiments, the light guide comprising the turning features and the first reflector can be formed as a single piece, for example, by molding. In some embodiments, the first reflector may be laterally disposed with respect to one or more edges of the light guide. In various embodiments, the reflector may comprise one or more curved surfaces. In some embodiments, the curved surfaces of the reflector may comprise cylindrical surfaces. In various embodiments, the curved surfaces of the reflector may comprise parabolic or elliptical surfaces. In some embodiments, the first reflector may comprise a curved cross-section. The curved cross-section may be circular, elliptical, other conics or aspheric. In some embodiments, the reflector may comprise metal. In certain embodiments, the reflector may comprise a partially reflecting surface coated with a reflecting layer (e.g. metal or a dielectric). In some embodiments, the reflecting layer may comprise a metallic coating, a dielectric coating, an interference coating, etc. In some embodiments, the first reflector may comprise an optical element configured to reflect light via total internal reflection. In various embodiments, the first reflector can comprise one or more Fresnel reflectors. As described above, in some embodiments, the light guide and the first reflector such as one or more Fresnel reflectors can be formed as a single piece, for example, by molding.

Various embodiments disclose a display device comprising a means for guiding light having a forward and a rearward surface. In various embodiments, the light guiding means can include a plurality of edges between the forward and the rearward surfaces. The display device comprises at least one light emitting means configured to inject light into the light guiding means such that light propagates through the light guiding means. In various embodiments, the display device further comprises a plurality of means for turning light configured to direct light propagating through the light guiding means towards the rearward surface of the light guiding means and at least one array of means for sensing light disposed forward of the light guiding means. The display device further comprises at least a first means for reflecting light disposed proximal to an edge of the light guiding means and configured to receive a portion of the light propagating within the light guiding means that approaches said edge and direct said portion of the light towards the sensing means.

In some embodiments, the first reflecting means may be disposed at one edge of the light guiding means and configured to receive a portion of the light propagating within the light guiding means that reaches said edge and direct said portion of the light towards the sensing means. In various embodiments, the first light reflecting means forms the edge of the light guiding means. For example, in various embodiments, the light guiding means comprising the light turning means and the first light reflecting means can be formed as a single piece, for example, by molding. In some embodiments, the first light reflecting means may be laterally disposed with respect to one or more edges of the light guiding means. In various embodiments, the light reflecting means may comprise one or more curved surfaces. In some embodiments, the curved surfaces of the light reflecting means may comprise cylindrical surfaces. In various embodiments, the curved surfaces of the light reflecting means may comprise parabolic or elliptical surfaces. In some embodiments, the light reflecting means may comprise a curved cross-section. The curved cross-section may be circular, elliptical, other conics or aspheric. In some embodiments, the light reflecting means may comprise metal. In certain embodiments, the light reflecting means may comprise a partially reflecting surface coated with a reflecting layer (e.g. metal or a dielectric). In some embodiments, the reflecting layer may comprise a metallic coating, a dielectric coating, an interference coating, etc. In some embodiments, the light reflecting means may comprise an optical element configured to reflect light via total internal reflection. In various embodiments, the first light reflecting means can comprise one or more Fresnel reflectors. As described above, in some embodiments, the light guiding means and the first light reflecting means such as one or more Fresnel reflectors can be formed as a single piece, for example, by molding.

Various embodiments disclose a method of manufacturing a display device. The method comprises providing a light guide having a forward and a rearward surface and a plurality of edges between the forward and the rearward surfaces. The method further comprises providing at least one light source configured to inject light into the light guide such that light propagates through the light guide. In various embodiments, the method further includes including a plurality of turning features configured to direct light propagating through the light guide towards the rearward surface of the light guide and providing at least one array of sensors disposed forward of the light guide. The method further includes providing at least a first reflector that is disposed proximal to an edge of the light guide and configured to receive a portion of the light propagating within the light guide that approaches said edge and direct said portion of the light towards the at least one array of sensors. In some embodiments, the first reflector may be disposed at one edge of the light guide and configured to receive a portion of the light propagating within the light guide that reaches said edge and direct said portion of the light towards the at least one array of sensors.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8A schematically illustrates a perspective view of an embodiment of a display device comprising a front illuminator.

FIG. 8B schematically illustrates a cross-section view of the display device illustrated in FIG. 8A.

FIG. 9 schematically illustrates a perspective view of an embodiment of an optical touch screen.

FIG. 10 schematically illustrates light propagating through the light guide of an embodiment of a display device.

FIG. 11 schematically illustrates the side view of an embodiment of a display device comprising a reflector and a sensor.

FIG. 12A schematically illustrates the perspective view of a display device comprising a front light and an optical touch screen.

FIG. 12B schematically illustrates the top view of an alternate embodiment of the display device illustrated in FIG. 12A comprising a curved reflector.

FIG. 12C schematically illustrates the top view of an alternate embodiment of the display device illustrated in FIG. 12A comprising a Fresnel reflector.

FIG. 13A schematically illustrates the perspective view of an embodiment of a display device comprising a light guide having turning features along one edge of the light guide integrated with an optical touch screen.

FIG. 13B schematically illustrates the side view of the display device illustrated in FIG. 13A.

FIG. 14A schematically illustrates the side view of a display device comprising a light guide having slits and an optical element to couple light emitted from an edge of a light guide onto a reflector.

FIG. 14B schematically illustrates the side view of an alternate embodiment of the display device illustrated in FIG. 14A, wherein the optical element comprises collimating slits.

### DETAILED DESCRIPTION OF THE PREFERRED EMBODIMENT

The following detailed description is directed to certain specific embodiments. However, the teachings herein can be applied in a multitude of different ways. In this description, reference is made to the drawings wherein like parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

As discussed more fully below, in certain preferred embodiments an optical touch screen may be integrated in the display device to allow a user to interact with the display device. The display device can comprise a plurality of display elements that include one or more interferometric modulators. The display device can further include a light guide disposed forward of the display elements and a front light source to provide light to the display elements. The front light source can be configured to inject light into the light guide such that light is propagated through the light guide. In some embodiments, the light can be guided within the light guide by multiple total internal reflections. The light guide may comprise a plurality of turning features configured to direct the light propagating within the light guide towards the display elements. Certain embodiments of the display device described herein can comprise one or more reflectors configured to reflect light emitted from the light guide that is not directed towards the display elements such that the reflected light is directed above the light guide to form a “sheet of light” or a light grid. A plurality of sensor arrays configured to sense the sheet of light or light grid can be disposed above the light guide along one or more edges of the light guide. In various embodiments described herein, the position of an object (e.g. a pen, a finger, a stylus, etc.) obstructing or interrupting the propagation of the rays of light comprising the sheet of light can be determined by identifying those sensors that are blocked.

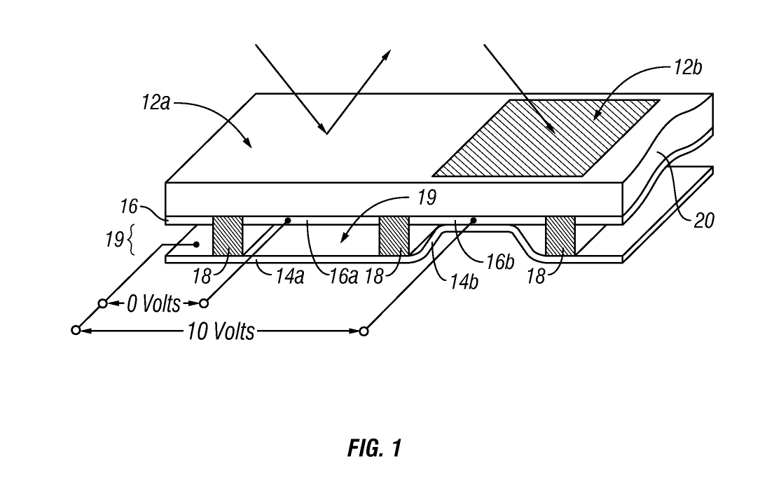

One interferometric modulator display embodiment comprising an interferometric MEMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) to form columns deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by actuated pixel 12b on the right in FIG. 1. The behavior is the same regardless of the polarity of the applied potential difference.

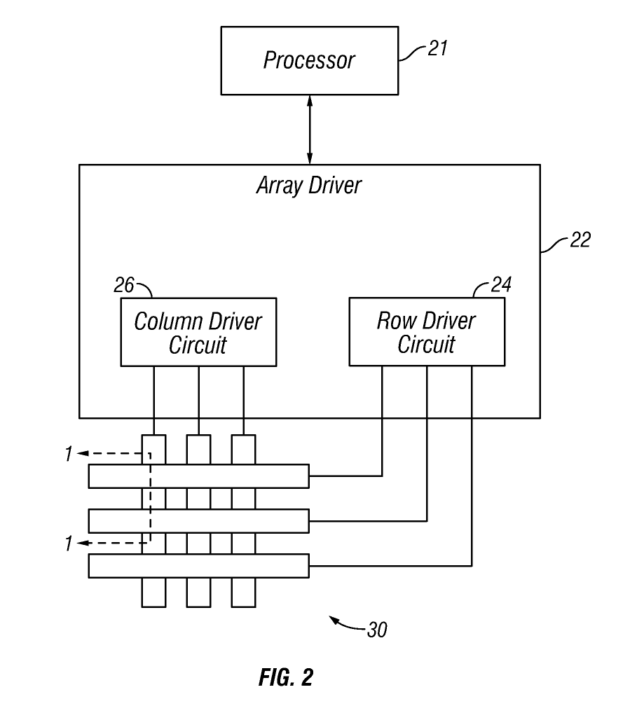

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

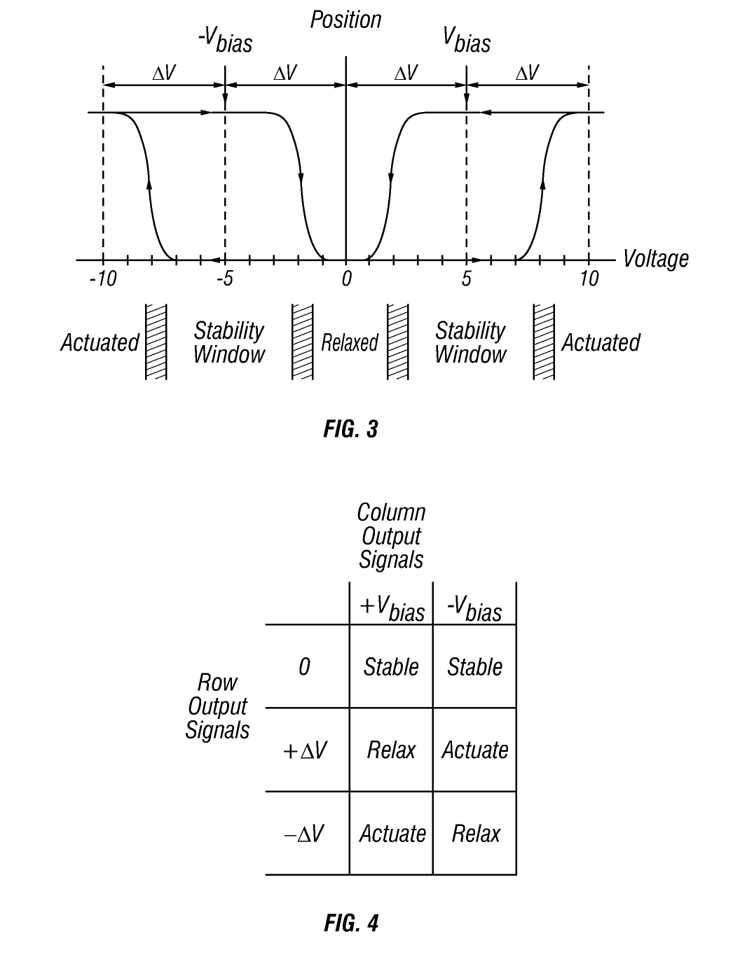

FIG. 3 is a diagram of movable mirror position versus applied voltage for one exemplary embodiment of an interferometric modulator of FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

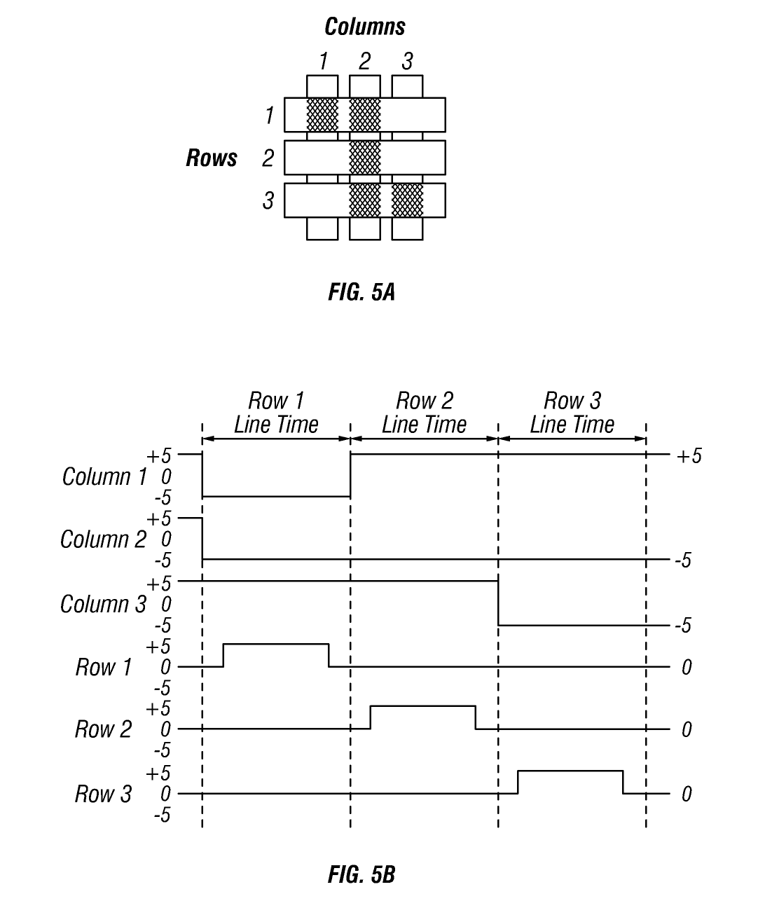

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are initially at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. The same procedure can be employed for arrays of dozens or hundreds of rows and columns. The timing, sequence, and levels of voltages used to perform row and column actuation can be varied widely within the general principles outlined above, and the above example is exemplary only, and any actuation voltage method can be used with the systems and methods described herein.

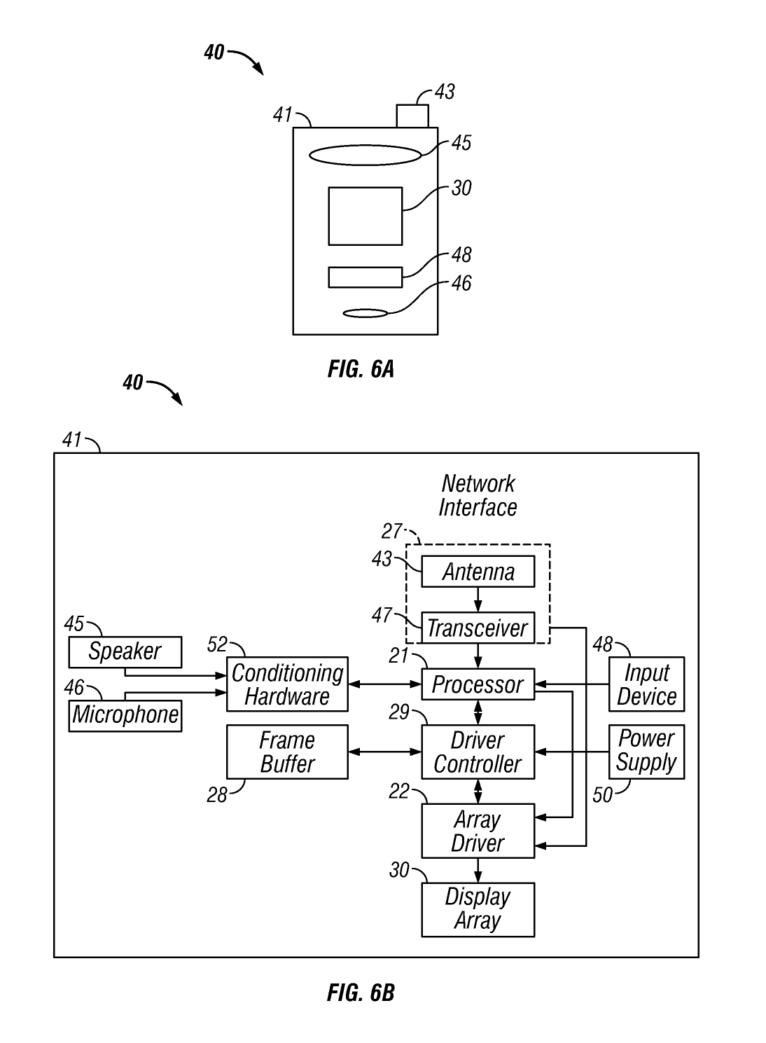

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

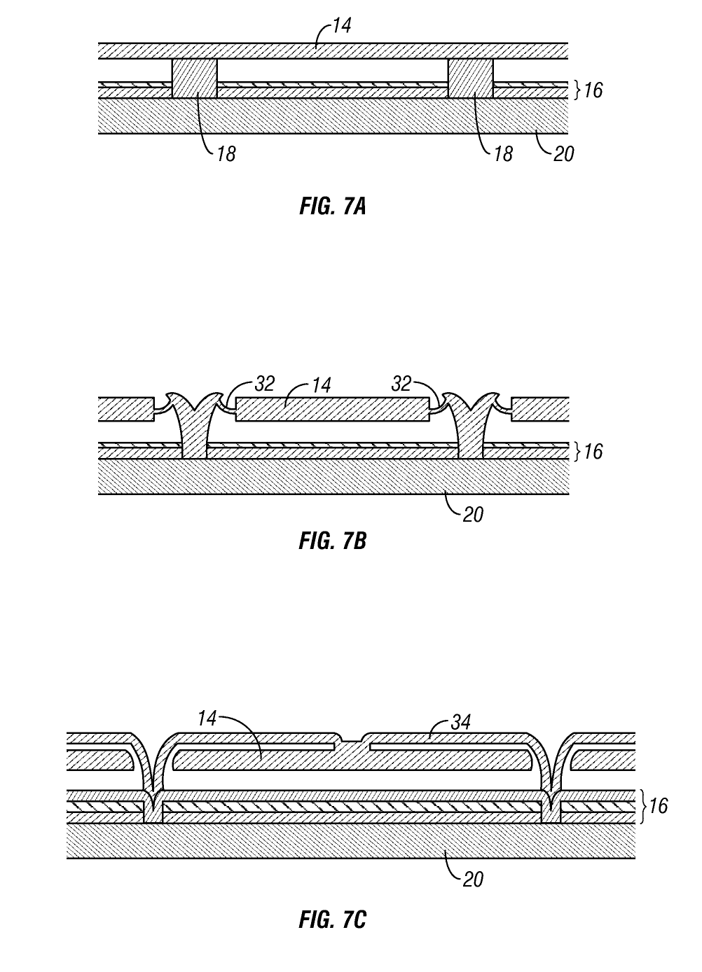

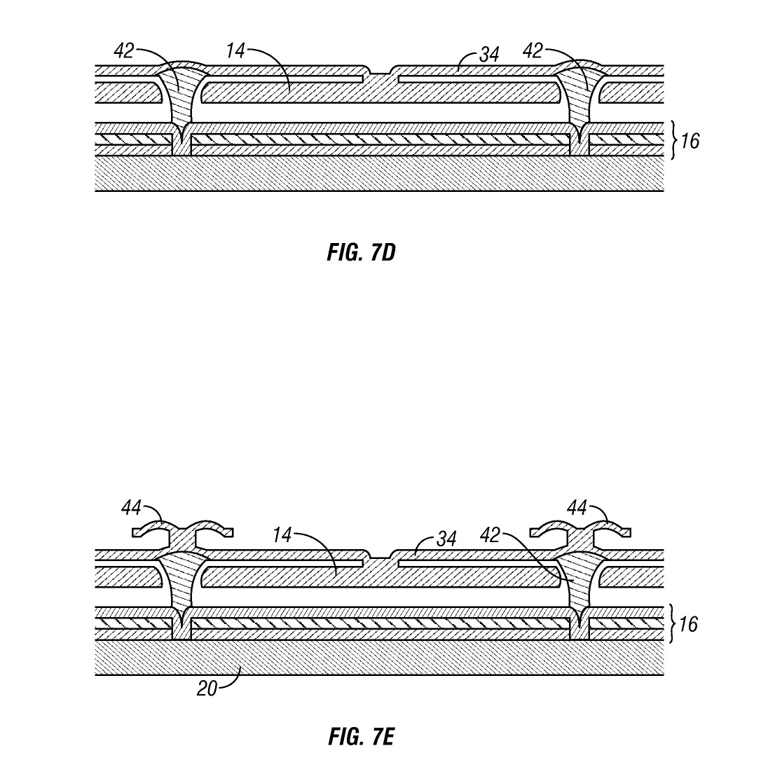

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

As described above, the interferometric modulators are reflective display elements and in some embodiments can rely on ambient lighting in daylight or well-lit environments for providing illumination to the display elements. In some embodiments, an internal source of illumination can be provided for illuminating these reflective display elements in dark ambient environments. In some embodiments, the internal source of illumination can be provided by a front illuminator. In various embodiments, a portion of the light from the front illuminator can be directed towards an array of sensors which are included in an optical touch screen to enable an interactive and/or a user friendly display device. For example, in various embodiments, the optical touch screen can enable a user to move an object (e.g. a finger, a pen, a stylus, etc.) across the display system to perform functions such as, but not limited to, opening applications, scrolling up or down across a window, input information, etc. Embodiments of display systems with integrated optical touch screen can be implemented in or associated with a variety of electronics devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, etc.

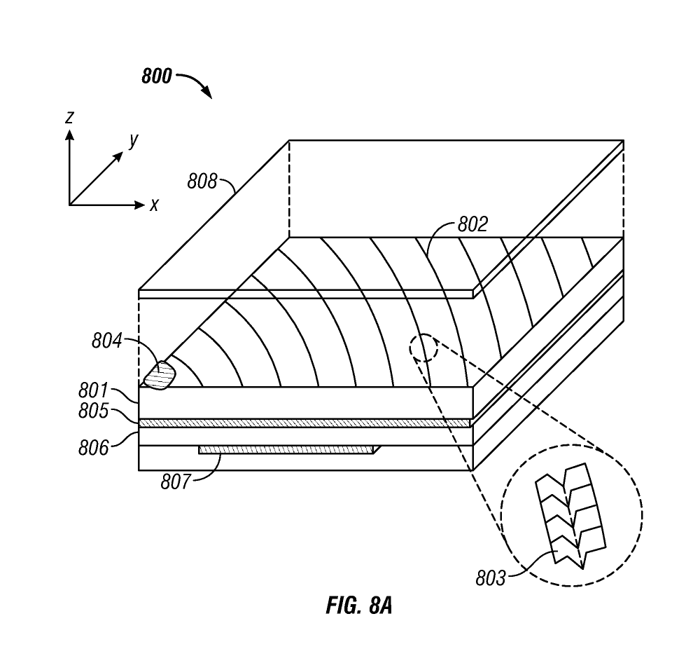

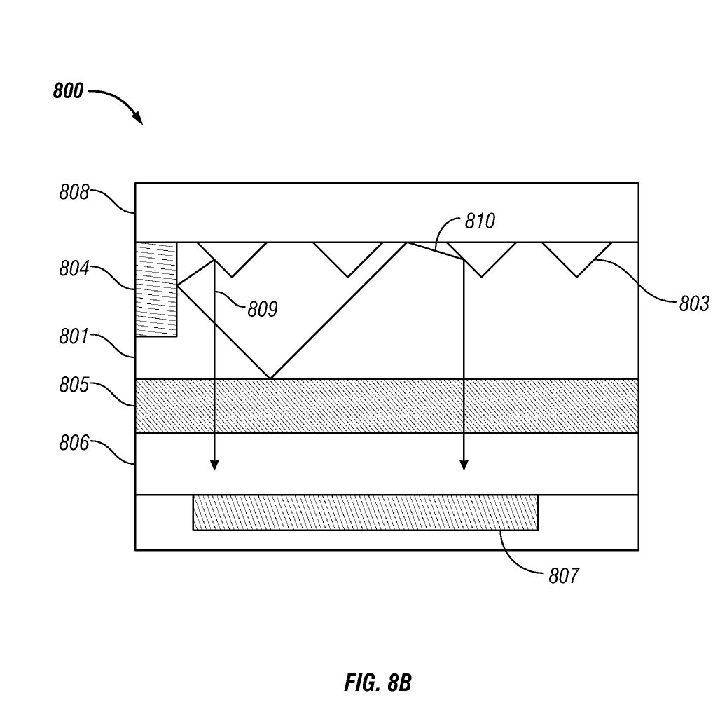

FIG. 8A schematically illustrates a perspective view of an embodiment of a display device 800 comprising a front illuminator. The display device 800 comprises display elements 807, a light guide 801 including a plurality of turning features 803 and a light source 804. In some embodiments, the display elements 807 may comprise reflective display elements. In various embodiments, the display elements 807 may comprise interferometric modulators. In some embodiments, the display elements 807 may be formed on an optically transmissive substrate 806. The substrate 806 may provide structural support during and after fabrication of the display elements 807 thereon. The substrate 806 may be substantially transparent such that a viewer can see the display elements 807 through the substrate. In some embodiments, the substrate 806 may comprise glass or plastic although other materials may also be used.

In some embodiments, the light guide 801 can be disposed forward of the display elements 807. The light guide 801 may have a forward and a rearward surface and include a plurality of edges between the forward and the rearward surfaces. The light guide 801 may comprise optically transmissive material e.g., glass or plastic. In various embodiments, the light guide 801 may be rigid or flexible. In some embodiments, the light guide 801 may be adhered to the substrate 806 using a low refractive index adhesive layer 805 e.g., pressure sensitive adhesive (PSA). In some embodiments, the adhesive layer 805 may comprise a diffusive layer. The light guide 801 may further comprise a plurality of turning features 803. In some embodiments, the plurality of turning features 803 may comprise elongate grooves, linear v-grooves, prismatic features, diffractive optical elements, volume or surface holograms and/or linear or curvilinear facets. The plurality of turning features 803 may be arranged linearly or along curved paths 802 on the forward surface of the light guide 801. In some embodiments, the curve paths 802 may be concentric having a center of curvature located at or near one corner of the light guide 801. The turning features 803 may be formed by a variety of techniques such as embossing, or etching. Other techniques of forming the turning features 803 may also be used. In some embodiments, the turning features 803 may be formed or disposed on a film that forms a part of the light guide 801 and is adhered to a surface of the light guide 801 (e.g. by lamination, by PSA, etc.). Although FIG. 8A illustrates the turning features disposed on the forward surface of the light guide 801, in various embodiments, the turning features can be disposed on the rearward surface of the light guide 801 as well.

The light source 804 in the display device 800 illustrated in FIG. 8A can be disposed in one corner of the light guide 801. In various embodiments, the light source 804 may be located at the center of curvature of the concentric curved paths 802 comprising turning features 803. In some embodiments, the concave side of the curved paths 802 may face towards the light source 804. In some embodiments, the light source 804 may be disposed along one or more edges of the light guide 801. The light source 804 may comprise a light emitting device such as, but not limited to, one or more light emitting diodes (LED), a light bar or one or more lasers. In some embodiments, a cover layer 808 may be disposed forward of the light guide 801.

FIG. 8B schematically illustrates a cross-section view of the embodiment of the display device 800 illustrated in FIG. 8A. The light source 804 may be configured to inject light into one corner of the light guide 801. In some embodiments, the light source 804 may be configured to inject light into one or more edges of the light guide. The light injected from the light source 804 may be guided within the light guide 801 by successive multiple reflections between the forward and the rearward surfaces of the light guide 801. The propagation of the light within the light guide can be disrupted by the turning features 803, which are configured to redirect the guided light out of the light guide 801 towards the display elements 807. FIG. 8B shows the rays of light 809 and 810 that are directed out of the light guide 801 towards the display elements 807 by the turning features 803.

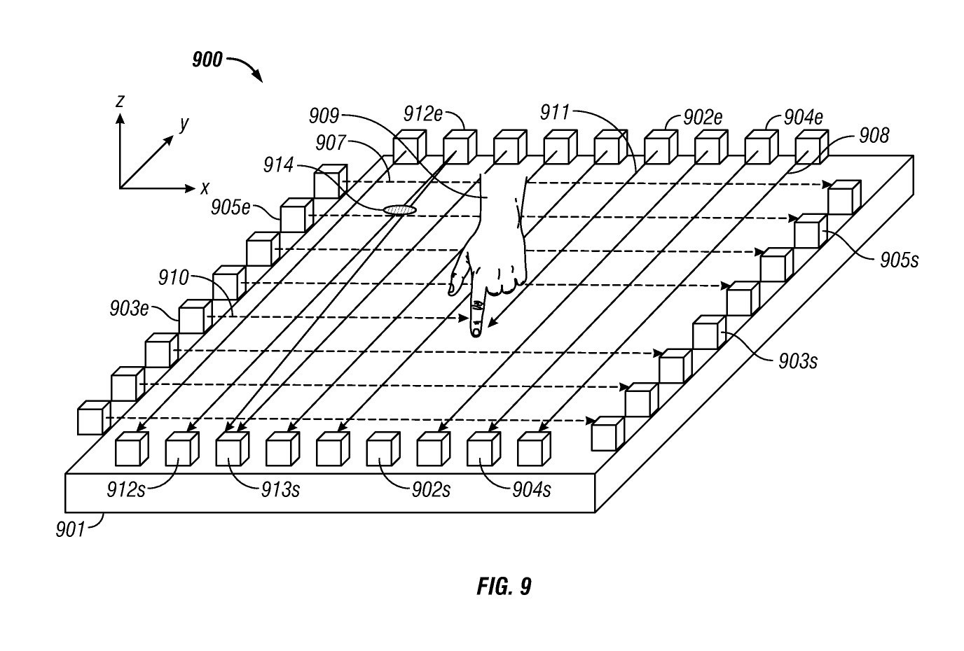

FIG. 9 schematically illustrates a perspective view of an embodiment of an optical touch screen 900. In some embodiments, the optical touch screen 900 comprises a touch surface 901, a plurality of arrays of sensors and a plurality of arrays of light emitters. The touch surface 901 may be a rigid or a flexible surface. The plurality of arrays of sensors may comprise individual sensors e.g., 902s, 903s, 904s and 905s. The plurality of arrays of light emitters may comprise individual light emitters e.g., 902e, 903e, 904e and 905e. In some embodiments, the plurality of arrays of sensors may comprise one or more photo-receivers and/or photo-diodes, while the plurality of arrays of light emitters may comprise LEDs and/or laser diodes. Other types of sensors and light emitters are also possible. In some embodiments, the plurality of arrays of sensors and light emitters may be arranged along two edges of the touch surface 901. For example, the optical touch screen illustrated in FIG. 9 comprises a first array of sensors arranged along a first edge of the touch surface 901 parallel to the x-axis and a second array of sensors arranged along a second edge of the touch surface 901 parallel to the y-axis. The embodiment of the optical touch screen illustrated in FIG. 9 comprises a first array of light emitters arranged along a third edge of the touch surface 901 parallel to the x-axis opposite the first edge and a second array of light emitters arranged along a fourth edge of the touch surface 901 parallel to the y-axis opposite the second edge.

In some embodiments of the optical touch screen 900, the light emitters and the sensors form a plurality of emitter/sensor pairs disposed or arranged along directions parallel to the x-axis and the y-axis. The emitter/sensor pairs are configured such that light emitted from an emitter is directed towards a corresponding sensor positioned opposite the emitter and is detected by the sensor. For example, light emitted from the emitters 903e and 905e is directed toward sensors 903s and 905s respectively that are positioned opposite the emitters 903e and 905e. Similarly, light emitted from the emitters 902e and 904e is directed towards sensors 902s and 904s respectively that are positioned opposite the emitters 902e and 904e. The light emitted from the plurality of arrays of light emitters forms a light grid or a sheet of light over the touch surface 901. In some embodiments, the light beams (e.g., 907 and 908) forming the sheet of light or light grid may have substantially uniform distribution of luminous flux across the touch surface 901. Using such a system, the position of an object that touches the optical touch screen 900 can be determined. In various embodiments, for example, an object 909 such as, but not limited to, a finger, a pen, or a stylus touching or placed close to the touch surface 901 blocks the beam of light 910 emitted from the light emitter 903e and the beam of light 911 emitted from the light emitter 902e. Blocking beams of light 910 and 911 may cast a shadow on the sensors 903s and 902s configured to detect or sense the light emitted from the emitters 903e and 902e. The shadow may cause a change in the state of the sensors 903s and 902s. For example, in some embodiments, the shadow may cause a loss of signal in the sensors 903s and 902s. In some embodiments, the shadow may cause a reduction in the electrical voltage or electrical current output from the sensors 903s and 902s. The position of the object 909 in the x-y plane can be determined by identifying the sensors (e.g. 903s and 902s) that indicate a change of state.

In some embodiments, substantially collimating the rays of light forming the sheet of light or light grid along each of the directions parallel to the x-, y- and z-axis can advantageously increase the accuracy with which the position of the obstacle in the x-y plane can be determined. For example, in the embodiment illustrated in FIG. 9, the beam of light emitted from the emitter 912e is not collimated and diverges in the x-y plane parallel to the forward surface of the light guide 901 such that the light emitted from the emitter 912e is sensed not only by the corresponding sensor 912s but also by the neighboring sensor 913s. Thus, an object placed at the region of space indicated by reference numeral 914 will block the beam of light from the emitter 912e and trigger both sensors 912s and 913s to indicate a change of state. This can cause ambiguity in determining the position of the obstructing object. Thus, reducing the divergence of the beams emitted from the emitter can be beneficial. In some embodiments, the beam of light emitted from the emitter 912e can diverge in the plane perpendicular to the forward surface of the light guide and may not be directed towards any sensor. It may be beneficial to also reduce the divergence of the light in the plane perpendicular to the forward surface of the light guide to improve parameters such as signal-to-noise ratio and dynamic range of the optical touch screen.

In some embodiments, the divergence angle of rays of light forming the sheet of light or light grid are less than or equal to approximately ±45 degrees (e.g. ±45, ±30, ±25, ±20, etc.) as measured at full width half maximum in the plane parallel to the forward surface of the light guide. In some embodiments, the divergence angle of rays of light forming the sheet of light or light grid are less than or equal to approximately ±15 degrees as measured at full width half maximum in the plane perpendicular to the forward surface of the light guide. Although, the advantages of collimating the beams forming the sheet of light or light grid are discussed above, in some embodiments, techniques to achieve triangulation without collimation can also be used.

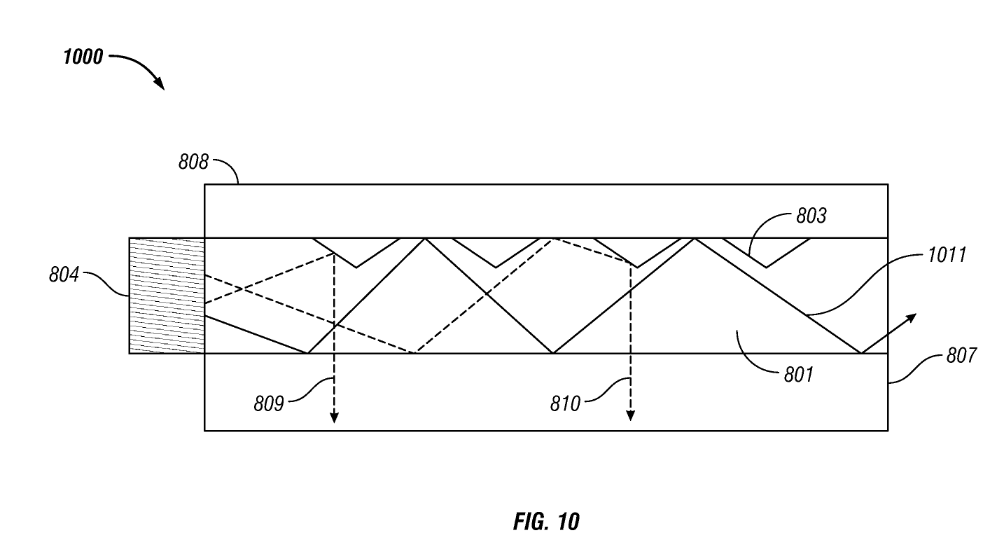

As discussed above, integrating an optical touch screen with a display system can provide several benefits. Systems and methods that can redirect a portion of the light from the front illuminator providing illumination to the display system, as described with reference to FIG. 8A and FIG. 8B, towards an array of sensors that are a part of the optical touch screen are described below. FIG. 10 schematically illustrates an embodiment of a display device 1000 comprising a light guide (e.g., light guide 801 of FIG. 8A), display elements (e.g., display elements 807 of FIG. 8A) and a source of light (e.g., light source 804 of FIG. 8A). As described above with reference to FIG. 8A and FIG. 8B, the light emitted from the source of light (e.g., light source 804 of FIG. 8A) is guided within the light guide (e.g., 801 of FIG. 8A) by multiple reflections from the forward and rearward surfaces of the light guide. In some embodiments, the light guide comprises a plurality of turning features (e.g., turning features 803 of FIG. 8A) that are configured to disrupt the light propagating within the light guide and redirect the guided light towards the display elements disposed rearward of the light guide. However, in some embodiments a portion of the guided light may not be redirected towards the display elements by the turning features and generally exits the light guide as illustrated by ray 1011 of FIG. 10. Similarly, in some embodiments, a portion of the light propagating through the light guide (e.g., guided or unguided) can exit the light guide. This portion of the guided and/or propagated light that exits the light guide through one or more edges is generally wasted. In some embodiments, approximately 20%-approximately 30% of the light guided and/or propagated within the light guide may not be directed towards the display elements and may exit the light guide. This portion of the light that exits the light guide can be redirected towards an array of sensors that are a part of the optical touch screen, described in FIG. 9 above.

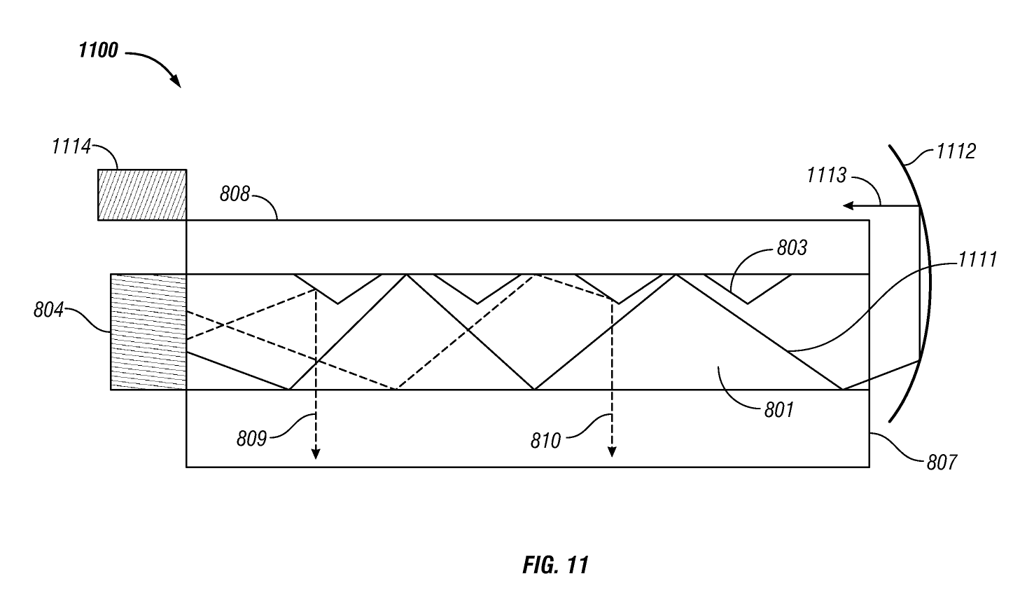

FIG. 11 illustrates an embodiment of a display device 1100 integrated with an optical touch screen comprising an array of sensors, wherein a portion of the light that is not directed towards the display elements and exits the light guide is redirected by a reflector towards the sensors. The display device 1100 comprises a plurality of display elements (e.g., display elements 807 of FIG. 8B), a light guide (e.g. light guide 801 of FIG. 8B), a light source (e.g., light source 804 of FIG. 8B), a reflector 1112 and an optical touch screen comprising an array of sensors 1114. In some embodiments of the display device 1100, the optical touch screen may comprise a touch surface (e.g. cover plate 808 of FIG. 8A) disposed forward of the light guide. The touch surface may comprise a rigid surface or a flexible surface. In some embodiments, the touch surface may be optically transmissive. In some embodiments, the touch surface may comprise a polymer. The array of sensors 1114 is disposed forward of the touch surface and the light guide. In some embodiments, the array of sensors may comprise a photo-detector array and/or a photo-receiver.

In the display device 1100, the reflector 1112 may be laterally disposed with respect to one or more edges of the light guide. In some embodiments, the reflector 1112 may comprise one or more curved surfaces. In some embodiments, the curved surfaces of the reflector 1112 may comprise cylindrical surfaces. In various embodiments, the curved surfaces of the reflector 1112 may comprise parabolic or elliptical surfaces. In some embodiments, the reflector 1112 may comprise a curved cross-section. The curved cross-section may be circular, elliptical, other conics or aspheric. In some embodiments, the reflector 1112 may comprise a metal. In certain embodiments, the reflector 1112 may comprise a partially reflecting surface coated with a reflecting layer (e.g. metal or a dielectric). In some embodiments, the reflecting layer may comprise a metallic coating, a dielectric coating, an interference coating, etc. In some embodiments, the reflector 1112 may comprise an optical element configured to reflect light via total internal reflection.

The reflector 1112 is configured to receive a portion of the light, for example, ray of light 1111 within the light guide that exits the light guide. The ray of light 1111 may be reflected one or more times by the reflector 1112 before being directed towards the sensor 1114. The reflected ray of light 1113 directed towards the sensor 1114 may propagate substantially parallel to the forward surface of the light guide and is used to form the sheet of light or light grid described above with reference to FIG. 9. In some embodiments, a prism may be used to direct the light that exits the light guide towards the sensor 1114. Similar to the embodiment 900, the display device 1100 integrated with an optical touch screen can be used to determine the position of an object including but not limited to a finger, a stylus, a pen, etc. that obstructs the sheet of light or light grid.

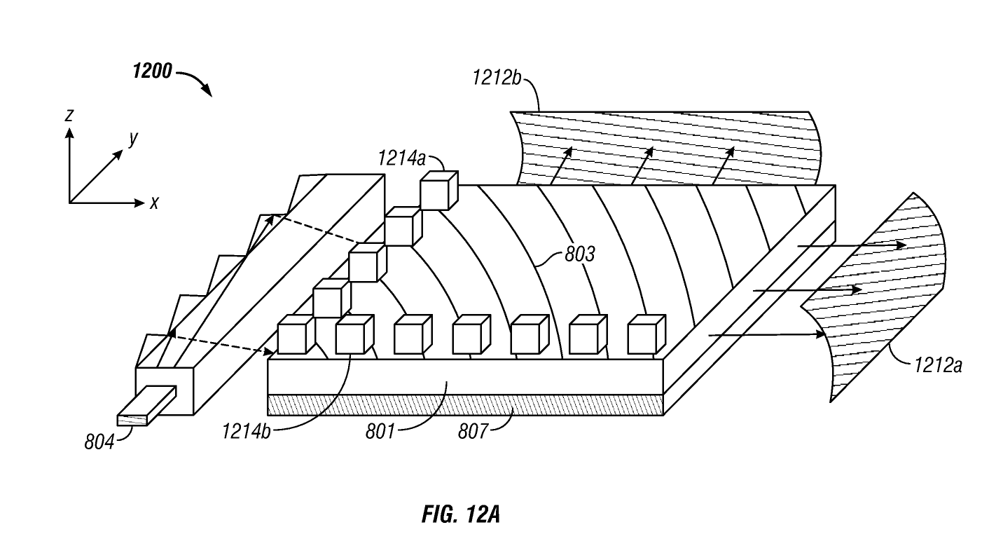

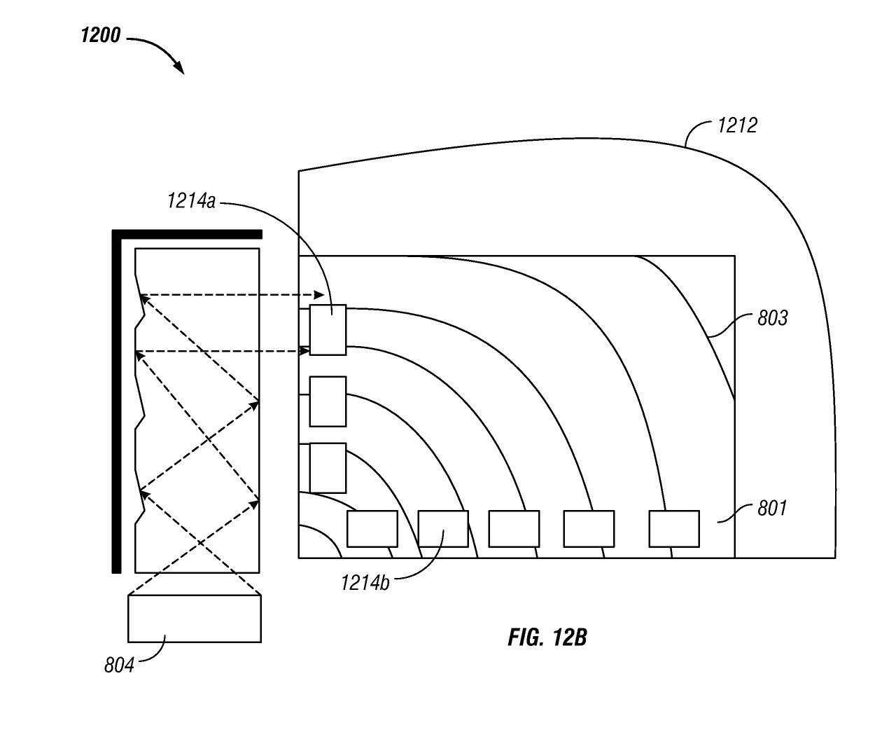

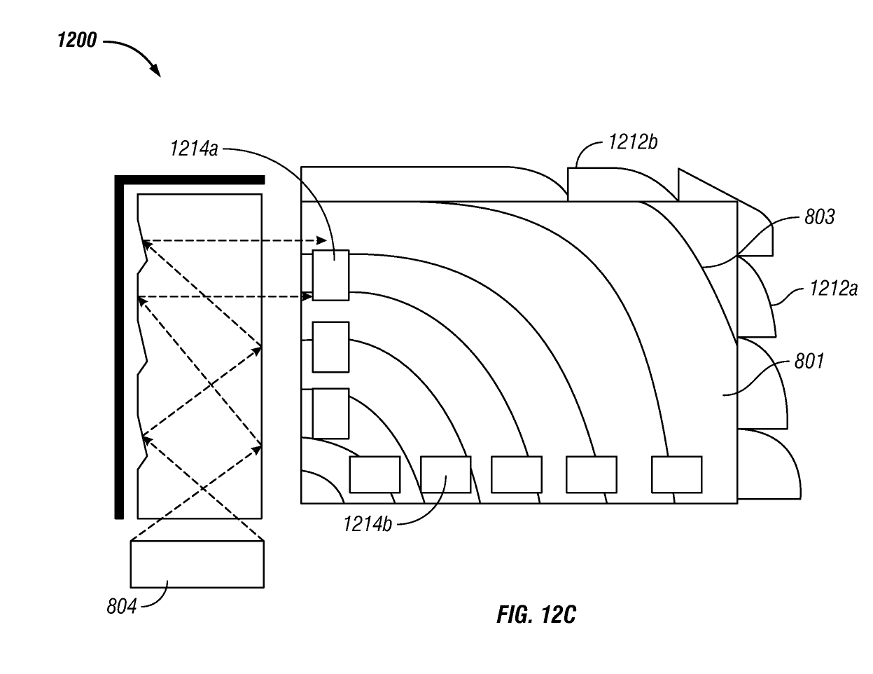

FIG. 12A schematically illustrates a perspective view of an embodiment of a display device 1200 comprising an integrated optical touch screen. The display device 1200 comprises display elements (e.g., display elements 807 of FIG. 8A), a source of light (e.g., source of light 804 of FIG. 8A) and a light guide (e.g., light guide 801 of FIG. 8A) comprising a plurality of turning features (e.g. turning features 803 of FIG. 8A). The display device 1200 also comprises a plurality of arrays of sensors 1214a and 1214b disposed above one or more edges of the light guide. The sensors in the plurality of sensor arrays 1214a and 1214b can be similar to the sensors described above with reference to FIGS. 9 and 11. The display device 1200 further comprises plurality of reflectors 1212A and 1212B. In some embodiments, the reflectors 1212A and 1212B may be curved in a plane perpendicular to the forward surface of the light guide. In some embodiments, the reflectors 1212A and 1212B may be cylindrical. In some embodiments, the reflectors 1212A and 1212B may be curved in planes perpendicular and parallel to the forward surface of the light guide. In some embodiments, the plurality of reflectors 1212A and 1212B may be molded into a single piece 1212, as illustrated in FIG. 12B, comprising a first curved surface that is curved in a plane parallel to the forward surface of the light guide and a plurality of curved surfaces that are curved in a plane perpendicular to the forward surface of the light guide. In some embodiments, the reflector 1212 may be formed by molding a plurality of reflecting surfaces having different shapes and curvatures. In some embodiments, the reflectors 1212A and 1212B may be shaped such that the reflected light is quasi-collimated. In some embodiments, the reflectors 1212A and 1212B may comprise a solid structure with one or more reflective surfaces. In some embodiments, the reflectors 1212A and 1212B may be adhered to the light guide, for example, bonded to the light guide or fused with the light guide. In various embodiments, the light guide comprising the turning features and the reflectors 1212A and 1212B can be formed as a single piece, for example, by molding.

Referring to FIG. 12A, the reflector 1212A is configured to (i) receive light emitted from an edge of the light guide along a direction substantially parallel to the +x-axis and (ii) redirect the received light such that it propagates above the forward surface of the light guide along a direction substantially parallel to the −x-axis towards the sensor array 1214a. Similarly, the reflector 1212B is configured to (i) receive light emitted from an edge of the light guide along a direction substantially parallel to the +y-axis and (ii) redirect the received light such that it propagates above the forward surface of the light guide along a direction substantially parallel to the −y-axis towards the sensor array 1214b. The light reflected from the reflectors 1212A and 1212B forms a light grid or a sheet of light in the plane above the forward surface of the light guide. In some embodiments, the light reflected by the reflectors 1212A and 1212B may be substantially collimated along the x, y and z axes. The position of an object that obstructs the light grid or sheet of light can be determined by identifying the individual sensors in the array of sensors 1214a and 1214b that exhibit a change of state (e.g. a loss of signal or a decrease in electrical voltage or current).

FIG. 12C illustrates the top view of an embodiment of a display device comprising an optical touch screen comprising a plurality of Fresnel reflectors 1212A and 1212B. The Fresnel reflectors, like a Fresnel lens, may be formed by dividing the continuous surface of the reflectors into a plurality of sections including discontinuities between them. In some embodiments, the Fresnel reflectors may comprise a plurality of prisms. The Fresnel reflectors may advantageously reduce the size (e.g. length, thickness, etc.) of the reflectors and in some embodiments, advantageously reduce the amount of material used to form the reflectors. In various embodiments, the Fresnel reflectors may be solid with a plurality of reflective surfaces. In some embodiments, the Fresnel reflectors may be molded into the light guide. In some embodiments, the Fresnel reflectors may be fused or bonded to the light guide. In various embodiments, other methods of forming the Fresnel reflectors and adhering the Fresnel reflectors to the light guide may be used. In various embodiments, the light guide comprising the turning features and the Fresnel reflectors can be integrally formed as a single piece, for example, by molding.

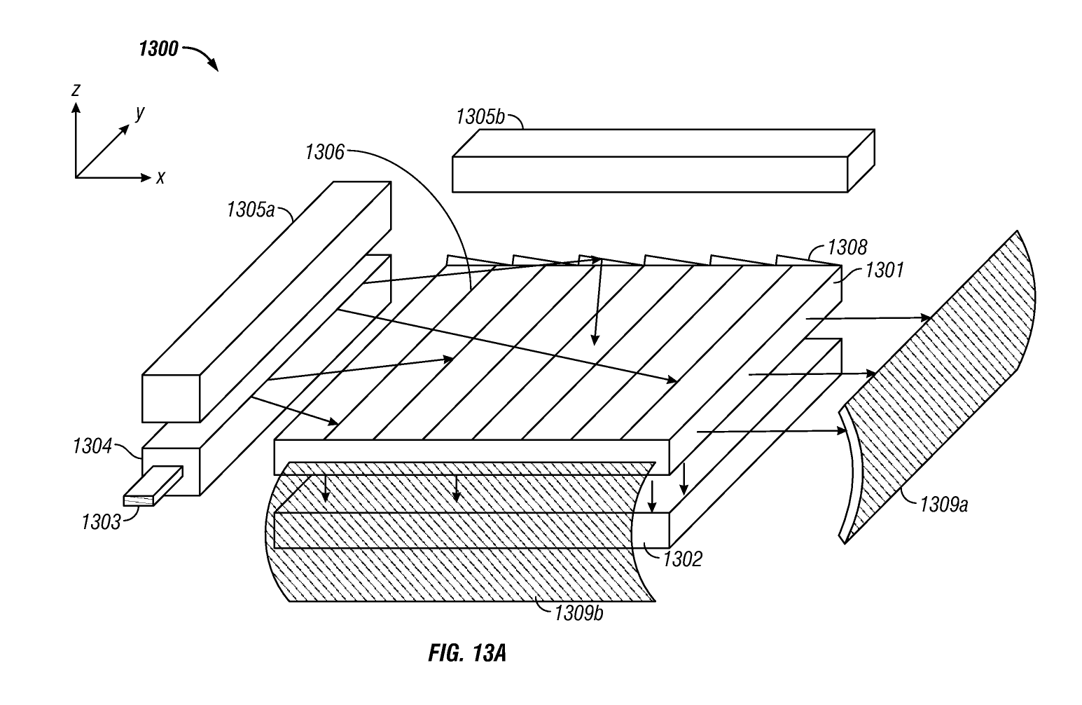

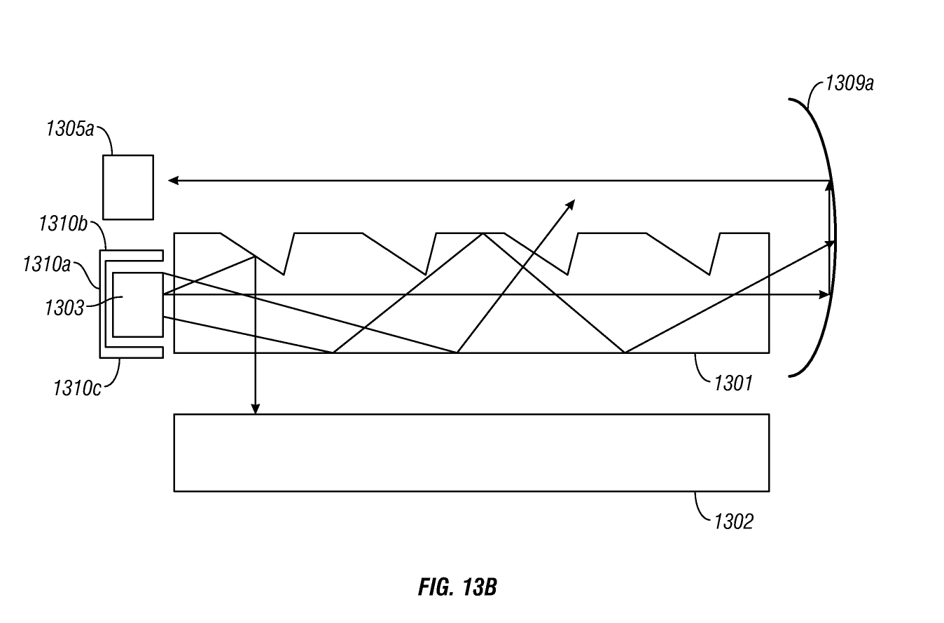

FIG. 13A illustrates a perspective view of an embodiment of a display device integrated with an optical touch screen comprising display elements 1302, a light guide 1301, a light bar 1304, a plurality of sensor arrays 1305a and 1305b and one or more reflectors 1309a and 1309b. In some embodiments, the display elements 1302 and the light guide 1301 may be similar to the display elements 807 of FIG. 8A and the light guide 801 of FIG. 8A, described above, respectively. The light guide 1302 can comprise a plurality of turning features 1306 on the forward surface of the light 1301. In some embodiments, the plurality of turning features 1306 can be similar to the turning features 803 of FIG. 8A and can be configured to redirect the light propagating through the light guide rearward towards the display elements 1302.

The light bar 1304 can be configured to receive light from a source of light 1303. In some embodiments the light source 1303 may comprise a light emitting diode, a laser, a fluorescent lamp or any other light emitting device. In some embodiments, the light source 1303 may be similar to light source 804 of FIG. 8A. Reflective surfaces, for example, reflective surfaces 1310a, 1310b and 1310c of FIG. 13B, can be disposed with respect to the edges of the light bar 1304 to reflect the light emitted from the light source 1303, into the space surrounding the light bar 1304, back into the light bar 1304.

In some embodiments, the light bar 1304 comprises substantially optically transmissive material that supports propagation of light along the length thereof. Light emitted from the light source 1303 can propagate into the light bar 1304 and be guided therein, for example, via total internal reflection at sidewalls of the light bar 1304. In some embodiments, the light bar 1304 may include turning features on a side opposite the light guide 1301 that are configured to turn a substantial portion of the light incident on that side of the light bar 1304 and direct a portion of this light out of the light bar 1304 into the light guide 1301. In certain embodiments, the illumination apparatus may further comprise a coupling optic (not shown) between the light bar 1304 and the light guide 1301. For example, the coupling optic may collimate light propagating from the light bar 1304. Other configurations are also possible.

The embodiment 1300 illustrated in FIG. 13A comprises a reflector 1309a configured to receive light emitted along a direction parallel to the +x-axis from an edge of the light guide 1301 and redirect the received light above the surface of the forward surface of the light guide 1301 along a direction parallel to the −x-axis towards the sensor array 1305a. In some embodiments, turning features 1308 may be disposed along one or more edges of the light guide 1301. In various embodiments, the turning features 1308 may be formed on one or more edges of the light guide 1301. In various embodiments, the turning features 1308 may comprise diffractive optical elements, prismatic features and/or surface or volume holograms. In some embodiments, the turning features 1308 can comprise facets. In the illustrated example, the turning features 1308 are configured to redirect light incident on the edge comprising the turning features 1308 along a direction parallel to the −y-axis. A reflector 1309b may be positioned along the edge opposite the edge including the turning features 1308 to receive light emitted along a direction parallel to the −y-axis and redirect the received light above the forward surface of the light guide 1301 along a direction parallel to the +y-axis towards the sensor array 1305b.

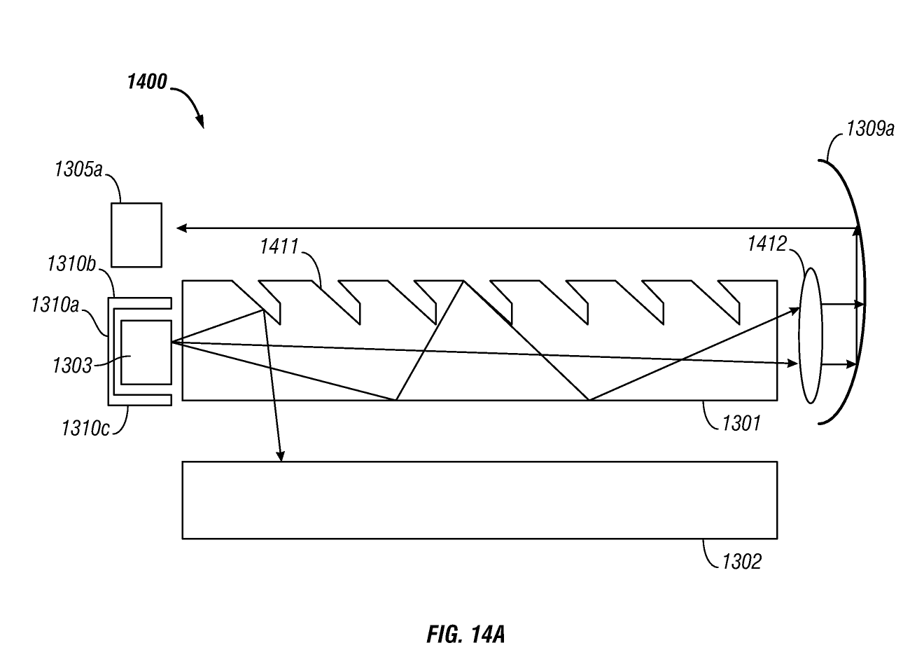

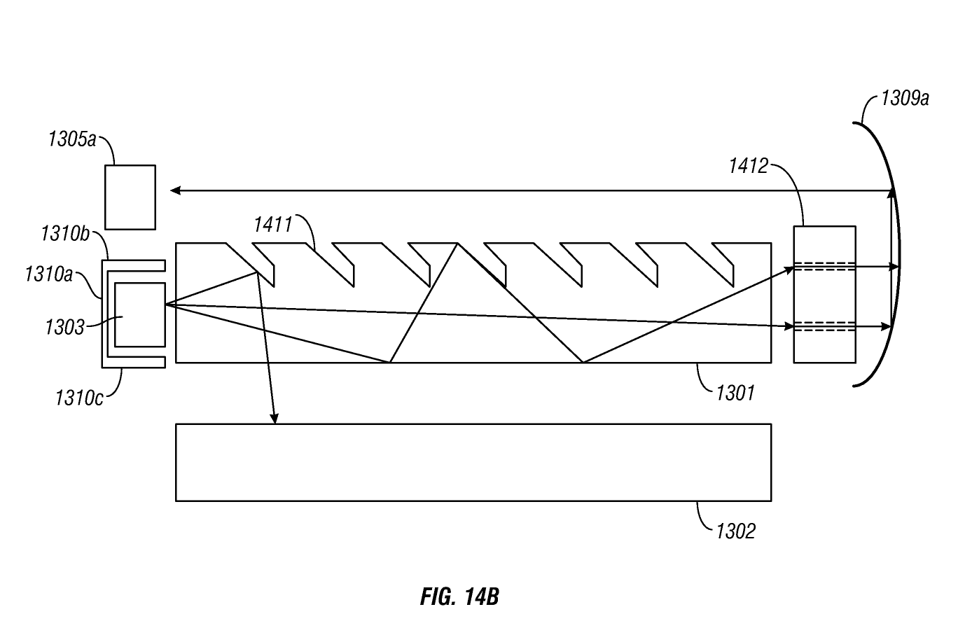

FIG. 14A illustrates a side view of an alternate embodiment of a display device 1400 comprising an optical touch screen wherein the light guide 1301 comprises slits 1411 disposed on the forward surface of the light guide 1301. In various embodiments, the slits 1411 may be configured to redirect the light that propagates through the light guide towards the rearward surface of the light guide. In some embodiments, the slits 1411 can advantageously reduce the amount of light guided within the light guide 1301 that leaks out of the light guide through the forward surface of the light guide. In some embodiments, the slits 1411 may be disposed on a turning film which is adhered to the light guide 1301. In some embodiments, the display device 1400 may comprise an optical element 1412 (e.g. a collimating lens) to collimate the light that exits from the edge of the light guide 1401 before being incident on the reflector 1409. Collimating the light that exits from the edge of the light guide 1301 before being incident on the reflector 1309 may advantageously reduce the divergence of the reflected light that is directed towards the sensor 1405 disposed forward of the light guide 1301.

In some embodiments, the optical element 1412 may be optically transmissive with a plurality of longitudinal passages or slits or separate channels as illustrated in FIG. 14B. The slits included in the optical element 1412 may allow only those rays of light that are collimated when the exit from an edge of the light guide 1301 and absorb or scatter those rays of light that are not collimated.

A wide variety of other variations are also possible. Films, layers, components, and/or elements may be added, removed, or rearranged. Additionally, processing steps may be added, removed, or reordered. Also, although the terms film and layer have been used herein, such terms as used herein include film stacks and multilayers. Such film stacks and multilayers may be adhered to other structures using adhesive or may be formed on other structures using deposition or in other manners.

The examples described above are merely exemplary and those skilled in the art may now make numerous uses of, and departures from, the above-described examples without departing from the inventive concepts disclosed herein. Various modifications to these examples may be readily apparent to those skilled in the art, and the generic principles defined herein may be applied to other examples, without departing from the spirit or scope of the novel aspects described herein. Thus, the scope of the disclosure is not intended to be limited to the examples shown herein but is to be accorded the widest scope consistent with the principles and novel features disclosed herein. The word “exemplary” is used exclusively herein to mean “serving as an example, instance, or illustration.” Any example described herein as “exemplary” is not necessarily to be construed as preferred or advantageous over other examples.

What is claimed is:

1. A display device comprising:
a light guide having a forward and a rearward surface, the light guide further comprising a plurality of edges between the forward and the rearward surfaces;
at least one light source configured to inject light into the light guide such that light propagates through the light guide;
a plurality of turning features configured to direct light propagating through the light guide towards the rearward surface of the light guide;
at least one array of sensors disposed forward of the light guide; and
at least a first reflector configured to receive a portion of the light propagating within the light guide that exits the light guide through one of the edges and to direct said portion of the light towards the array of sensors.

2. The device of claim 1, further comprising a plurality of light modulating elements rearward of said light guide such that said light directed towards the rearward surface of the light guide by said turning features is incident on said light modulating elements.

3. The device of claim 2, wherein said plurality of light modulating elements comprise a plurality of interferometric modulators.

4. The device of claim 1, wherein the light source comprises a light bar.

5. The device of claim 1, wherein the light source injects light into at least one edge of the light guide.

6. The device of claim 1, wherein the light source comprises a light emitting diode.

7. The device of claim 1, wherein the light source injects light into a corner of the light guide.

8. The device of claim 1, wherein the plurality of turning features comprises elongate grooves.

9. The device of claim 8, wherein the elongate grooves are curved so as to follow curved paths as viewed along a direction perpendicular to the forward surface of the light guide.

10. The device of claim 9, wherein the curved elongate grooves further comprise a concave side configured such that the concave side faces the light source.

11. The device of claim 1, wherein the plurality of turning features comprises v-grooves.

12. The device of claim 1, wherein the plurality of turning features comprises slits.

13. The device of claim 12, wherein the slits are linear and follow straight path as viewed along a direction perpendicular to the forward surface of the light guide.

14. The device of claim 12, wherein the slits are curved so as to follow curved paths as viewed along a direction perpendicular to the forward surface of the light guide.

15. The device of claim 14, wherein the curved paths comprise a concave side configured such that the concave side faces the light source.

16. The device of claim 1, wherein the plurality of turning features is selected from a group consisting of: a plurality of reflective optical elements, one or more diffractive optical elements or one or more holographic optical elements.

17. The device of claim 1, wherein one of the edges of the light guide comprises turning features.

18. The device of claim 1, wherein the array of sensors comprises a plurality of photo-detectors.

19. The device of claim 1, wherein the array of sensors is arranged along one edge of the light guide.

20. The device of claim 19, further comprising a second array of sensors arranged along another edge of the light guide.

21. The device of claim 1, wherein the first reflector is disposed laterally with respect to an edge of the light guide to receive light therefrom.

22. The device of claim 1, wherein the first reflector at least partially overlaps two edges of the light guide.

23. The device of claim 1, further comprising a second reflector disposed laterally with respect to an edge of the light guide to receive light therefrom.

24. The device of claim 23, wherein one of the edges of the light guide comprises turning features.

25. The device of claim 1, wherein a portion of the first reflector has a first curvature, the first curvature being curved in a plane parallel to the forward surface of the light guide.

26. The device of claim 25, wherein the first curvature is parabolic or elliptical.

27. The device of claim 1, wherein a portion of the first reflector has a second curvature, the second curvature being curved in a plane perpendicular to the forward surface of the light guide.

28. The device of claim 27, wherein the second curvature is parabolic or elliptical.

29. The device of claim 1, wherein the first reflector comprises a Fresnel reflector.

30. The device of claim 23, wherein the second reflector comprises a Fresnel reflector.

31. The device of claim 1, further comprising an optical element configured to substantially collimate the portion of the light that exits the light guide through said one of the edges and direct said collimated light towards the reflector.

32. The device of claim 31, wherein the optical element comprises a collimating lens.

33. The device of claim 31, wherein the optical element comprises a medium having a plurality of longitudinal passages.

34. The device of claim 1, wherein the light incident on the array of sensors has a divergence angle of no more than approximately ±45 degrees as measured at full width half maximum in the plane parallel to the forward surface of the light guide.

35. The device of claim 1, wherein the light incident on the array of sensors has a divergence angle of no more than approximately ±30 degrees as measured at full width half maximum in the plane parallel to the forward surface of the light guide.

36. The device of claim 1, wherein the light incident on the array of sensors has a divergence angle of no more than approximately ±15 degrees as measured at full width half maximum in the plane perpendicular to the forward surface of the light guide.

37. The device of claim 1, wherein a portion of the propagated light not turned towards the rearward surface by the turning features is directed towards the array of sensors by said at least first reflector.

38. The device of claim 1, wherein a portion of the light propagating through the light guide is guided within the light guide due to total internal reflection from the forward and rearward surfaces.

39. The device of claim 2, further comprising:
a display;
a processor that is configured to communicate with said display, said processor being configured to process image data; and
a memory device that is configured to communicate with said processor.

40. The device as recited in claim 39, further comprising:
a driver circuit configured to send at least one signal to said display.

41. The device as recited in claim 40, further comprising:
a controller configured to send at least a portion of said image data to said driver circuit.

42. The device as recited in claim 39, further comprising:
an image source module configured to send said image data to said processor.

43. The device as recited in claim 42, wherein said image source module comprises at least one of a receiver, transceiver, and transmitter.

44. The device as recited in claim 39, further comprising:
an input device configured to receive input data and to communicate said input data to said processor.

45. A display device comprising:
a means for guiding light having a forward and a rearward surface, the light guiding means further comprising a plurality of edges between the forward and the rearward surfaces;
at least one light emitting means configured to inject light into the light guiding means such that light propagates within the light guiding means;
a plurality of means for turning light configured to direct light propagating within the light guiding means towards the rearward surface of the light guiding means;
means for sensing light disposed forward of the light guiding means; and
at least one means for reflecting light configured to receive a portion of the propagating light that exits the light guiding means through one of the edges and to direct said portion of the light towards the array of sensing means.

46. The device of claim 45, wherein the light guiding means comprises a light guide.

47. The device of claim 45, wherein the light emitting means comprises a source of light.

48. The device of claim 45, wherein the light turning means comprises turning features.

49. The device of claim 45, wherein the sensing means comprises one or more arrays of sensors.

50. The device of claim 45, wherein the reflecting means comprises a reflector.

51. The device of claim 45, wherein a portion of the propagated light not turned towards the rearward surface by the light turning means is directed towards the array of sensing means by said at least one reflecting means.

52. The device of claim 45, wherein a portion of the light propagating through the light guiding means is guided within the light guiding means due to total internal reflection from the forward and rearward surfaces.

53. A method of manufacturing a display device, the method comprising:
providing a light guide comprising a forward and a rearward surface and a plurality of edges between said forward and rearward surfaces;
providing at least one light source configured to inject light into the light guide such that light propagates through the light guide;
including a plurality of turning features on the light guide, said turning features configured to direct light propagating through the light guide towards the rearward surface of the light guide;
providing at least one array of sensors disposed forward of the light guide; and
providing at least one reflector configured to receive a portion of the light propagating within the light guide that exits the light guide through one of the edges and to direct said portion of the light towards the array of sensors.

54. The method of claim 53, wherein the plurality of turning features are disposed on the forward surface of the light guide.

55. The method of claim 53, wherein said at least one reflector is molded to said light guide.

56. A method of using a display device comprising an optical touch screen, the method comprising:
injecting light from a light source into a light guide comprising a forward and a rearward surface and including a plurality of edges between said forward and rearward surfaces;
propagating the injected light through the light guide;
redirecting a portion of the propagated light that exits the light guide towards at least one array of sensors using at least one reflector, said at least one array of sensors comprising a plurality of sensors configured to sense the redirected light;
forming a sheet of light forward of the light guide, said sheet of light comprising the redirected light; and
determining a position of an object obstructing said sheet of light by detecting a change of state in one or more sensors.

57. The method of claim 56, wherein the light is injected into an edge of the light guide.

58. The method of claim 56, wherein a portion of the injected light is guided within the light guide and redirected by a plurality of turning features towards a plurality of display elements disposed rearward of said light guide.

59. The method of claim 58, wherein the display elements comprise a plurality of interferometric modulators.

60. The method of claim 56, wherein detecting a change of state in one or more sensors comprises detecting a loss of signal in said one or more sensors.
